(19) United States
(12) Patent Application Publication
(10) Pub. No.: US 2006/0081525 A1
(43) Pub. Date: Apr. 20, 2006

(54) Fibers with axial capillary slot that enhances adsorption, absorption and separation

(76) Inventors: Alex Lobovsky, Westfield, NJ (US); Wesley P. Hoffman, Palmdale, CA (US); Phillip G. Wapner, Palmdale, CA (US)

Correspondence Address: DEPARTMENT OF THE AIR FORCE, AFMC LO/JAZ, 2240 B ST., RM. 100, WRIGHT-PATTERSON AFB, OH, 45433-7109, US

(21) Appl. No.: 11/256,280

(22) Filed: Oct. 19, 2005

Related U.S. Application Data
(60) Provisional application No. 60/619,983, filed on Oct. 19, 2004.

(51) Int. Cl. B01D 63/02

(52) U.S. Cl. 210/321.88; 210/500.23; 96/10; 210/321.89

(57) ABSTRACT

New fluid separation devices and absorption materials are disclosed. Axially slotted hollow fibers act as very high efficiency absorption materials, as well as high-surface-area fluid separation devices. The slotted fibers are constructed to preferentially absorb or repel different fluids and arranged to maximize that action over a plurality of fibers to separate different fluids. These separation devices can also function as injection devices and very effective micro-reactors.

### CROSS-REFERENCE TO RELATED APPLICATIONS

This application claims priority of the filing date of Provisional Application Ser. No. 60/619,983, filed Oct. 19, 2004.

### RIGHTS OF THE GOVERNMENT

The invention described herein may be manufactured and used by or for the Government of the United States for all governmental purposes without the payment of any royalty.

### BACKGROUND OF THE INVENTION

The present invention relates generally to fluid absorption, adsorption and separation devices, and more particularly to hollow fibers having an axial slot that acts as a capillary along the length of the fiber. Such slotted fibers act as very high efficiency absorptive materials, as well as high-surface-area fluid separation devices.

Absorbent fibers in the form of hollow fibers and solid fibers with various cross-sectional shapes comprising ribs, wings, lobes, grooves and channels have found use in numerous health and industrial applications, such as, towels, diapers, feminine napkins, wound dressings and spill clean-up. Fibers with high absorption capacity have been described, for example, in U.S. Pat. Nos. 4,707,409; 5,057,368; 5,124,205; 5,200,248; 5,268,229; 5,496,627; 5,972,505; 5,977,429; 6,093,491; and 6,296,8211. In addition, a recently issued patent to Lobovsky et al. (U.S. Pat. No. 6,753,083) incorporated herein by reference, teaches that fiber absorbency can be increased by optimizing the ratio of the square root of the sum of the cross-sectional areas of the channels in a filament to the sum of the channel opening dimensions. In the prior art, the ribs, wings, lobes, grooves and channels are on the exterior of the fiber and do not provide overlapping or parallel lobes that serve as capillary walls. Thus, these fibers can't be employed for continuous separation and do not have the capacity-for absorption of the slotted capillary fibers of the present patent.

The present invention describes fibers with an axial slot that behaves physically as if a capillary existed along the entire length of the fiber. Such a capillary slot along the entire length of a hollow fiber, instead of a capillary opening in only the ends of a hollow microscopic fiber, improves the efficiency of fluid entering the hollow fiber many orders of magnitude. This greatly increases the usefulness of these fibers over the prior art in the areas of adsorption, absorption and fluid separation.

Copending patent application U.S. patent application Ser. No. 10/435,008, titled “Separation Devices, incorporated herein by reference, describes separation devices which can separate fluids according to how they wet the inner walls of capillaries, as well as their chemical, electrical or magnetic selectivity. For a fluid that does not wet a particular capillary wall, the minimum cross-sectional dimension of that capillary can also be used as a separation mechanism because the pressure needed to force a non-wetting liquid into the capillary depends on its minimum cross-sectional dimension. That is, the pressure (P_{c}) required to force a non-wetting fluid into a cylindrical capillary is dependent on the minimum cross-sectional radius (r_{c}), the surface tension of the liquid (γ) and the contact angle (θ) that the liquid makes with the material that it is exposed to on the inner wall of the capillary. This dependence is expressed by the equation:
P_{c}=2γ cos θ/r_{c} (1)

For highly non-circular capillaries such as slots, this equation can be generalized to:
P_{c}=2γ cos θ/d (2)

where the radius has now been replaced by (d) which is the minimum slot dimension.

Fluid separation devices based on admittance/exclusion are described in the Separation Devices patent application. In those devices, a fluid stream or mixture that impinges on the ends of the capillaries at the entrance face of the fluid separation device can be separated on the basis of the exclusion of one or more components of the fluid stream or mixture by certain capillaries in the fluid separation device entrance face. This selective exclusion from discrete capillaries in the separation device face can be used to separate the components of two phase flows.

To function as a fluid separation device and separate fluids on the basis of their exclusion from certain capillaries, it is necessary that the different capillaries in the fluid separation device differ from one another in respect to at least one separation characteristic, such as their cross-sectional dimensions, wettability, chemical characteristics, electrical characteristics and magnetic characteristics. Except for dimensional differences, these separation characteristics arise from the character of the inner surface of the slot and inner wall of the capillary, which depends on the material(s) used to form these surfaces, any coating(s) on these surfaces or any modification(s) to the material(s) forming these surfaces, such as might be made by mechanical, chemical, physical, radiation or energetic particle means.

Thus, to function as a fluidic separation device based on admittance/exclusion, at least one of the capillaries in the separation device must possess at least one characteristic necessary to separate at least one of the fluids in the incident fluid stream or mixture from the others. That is, the device must possess at least one capillary that allows the entrance of at least one of the fluids in the stream or mixture and at the same time excluding at least one other component in the fluid stream or mixture. In addition, all the capillaries in the separation device that are able to admit a certain fluid should terminate at a precise position on the exit surface of the separation device, such that the effluent of all these capillaries is in common. This effluent can then be collected or can enter another separation device for further processing.

The example embodiments described in the Separation Devices patent application Ser. No. 10/340,381, are a clear advance over the prior art. Yet, further improvements over the prior art are possible and desirable.

It is, therefore, an object of the present invention to build on the teachings of the Separation Devices patent application to provide better and more efficient fluid separation and other functions.

It is a feature of the present invention that it will find valuable use for separating immiscible liquids such as fat, oils and water from one another.

It is another feature of the present invention that it will find valuable use for removing oxygen from jet fuel to increase turbine engine temperatures and efficiencies.

It is a further feature of the present invention that it will find valuable use for “Dry Feel” fabrics.

It is an advantage of the present invention that its ability to separate immiscible liquids will find valuable use for soaking up spills generally, and particularly for such important uses as cleaning up oil spills at sea.

It is another advantage of the present invention that it will improve hygiene adsorbents such as are used in diapers and tampons.

These and other objects, features and advantages of the present invention will become apparent as the description of certain representative embodiments proceeds.

### SUMMARY OF THE INVENTION

The present invention provides new fluid separation devices and high efficiency absorptive and adsorptive materials. The unique discovery of the present invention is that making an axial slot through the side of a hollow fiber to act as a capillary into the fiber greatly increases the efficiency and usefulness of such hollow fibers over such fibers having capillary entrances in only the ends of the fibers. Specifically, the rate of fluid movement through the axial slot as well as the total fluid capacity of the hollow fiber are greatly increased.

Accordingly, the present invention is directed toward the use of hollow fibers with at least one axial slot in a variety of applications. For example, if the interior surface of the slot as well as the hollow fiber interior have a certain surface characteristic such as, hydrophilicity, hydrophobicity, oleophilicity, oleophobicity, or a combination of these characteristics, these fibers can be used as selective absorption materials to absorb fluids or to separate fluids from one another.

For adsorption and separation, these hollow slotted fibers can be used as individual fibers or they can be joined together by techniques such as, weaving, matting, braiding, knitting, felting, and filament winding. Alternatively, the end(s) of the fibers can be manifolded together in a fluid separation device so that the total amount of fluid absorbed or separated from a mixture will not be limited by the volume of the fibers.

When these slotted hollow fibers are manifolded together, they can be utilized in the reverse sense to produce highly efficient fluid injectors, static mixers, pressure regulators, and micro-reactors. In these applications a fluid is ejected from the manifolded hollow fibers through the slot to a fluid stream that intimately surrounds these fibers.

### DESCRIPTION OF THE DRAWINGS

The present invention will be more clearly understood from a reading of the following detailed description in conjunction with the accompanying drawings.

FIG. 1 is a cross-sectional view of a first example embodiment of a slotted fiber according to the teachings of the present invention using overlapping lobes to form a continuous capillary slot.

FIG. 2 is a cross-sectional view of a second example embodiment of a slotted fiber according to the teachings of the present invention using overlapping lobes to form a continuous capillary slot.

FIG. 3 is a cross-sectional view of a third example slotted fiber embodiment of the present invention using overlapping lobes to form a continuous capillary slot.

FIG. 4 is a cross-sectional view of a fourth example embodiment of a slotted fiber according to the teachings of the present invention using overlapping lobes to form a continuous capillary slot.

FIG. 5 is a cross-sectional view of a fifth example embodiment of a slotted fiber according to the teachings of the present invention using parallel lobes to form a continuous capillary slot.

FIG. 6 is a cross-sectional view of a sixth example embodiment of a slotted fiber according to the teachings of the present invention using parallel lobes to form a continuous capillary slot.

FIG. 7a is a cross-sectional view of a seventh example embodiment of a slotted fiber according to the teachings of the present invention using diverging lobes to form a continuous capillary slot.

FIG. 7b is a cross-sectional view of an eighth example embodiment of a slotted fiber according to the teachings of the present invention using converging lobes to form a continuous capillary slot.

FIG. 8 is a schematic view of a first example embodiment of a separation device using slotted fibers according to the teachings of the present invention.

FIG. 9 is a schematic view of a second example embodiment of a separation device using slotted fibers according to the teachings of the present invention.

FIG. 10 is a schematic view of a third example embodiment of a separation device using slotted fibers according to the teachings of the present invention.

FIG. 11 is a cross-sectional view of a first example illustration of a bi-component fiber spinning method for making slotted fibers according to the teachings of the present invention.

FIG. 12 is a cross-sectional view of a second example illustration of a bi-component fiber spinning method for making slotted fibers according to the teachings of the present invention.

FIG. 13 is a cross-sectional view of a third example illustration of a bi-component fiber spinning method for making slotted fibers according to the teachings of the present invention.

FIG. 14 is a cross-sectional view of a fourth example illustration of a bi-component fiber spinning method for making slotted fibers according to the teachings of the present invention.

FIG. 15 is a cross-sectional view of a fifth example illustration of a bi-component fiber spinning method for making slotted fibers according to the teachings of the present invention.

FIG. 16 is a cross-sectional view of a sixth example illustration of a bi-component fiber spinning method for making slotted fibers according to the teachings of the present invention.

FIG. 17 is a cross-sectional view of a seventh example illustration of a bi-component fiber-spinning method for making slotted fibers according to the teachings of the present invention.

### DETAILED DESCRIPTION

The minimum open dimension of a capillary is what controls entrance into the capillary. As this dimension decreases, the force drawing wetting fluids into a capillary increases while the amount of pressure needed to force a non-wetting fluid into the capillary also increases. With fluid only able to enter the end of a capillary, efficiencies and flow rates are low. As described in the present description, efficiencies of fluid separation devices based on capillary effects or wettability effects can be increased by orders of magnitude over those described in the Separation Devices application by providing at least one continuous slot that functions in the same manner as a capillary along the whole axial length of a hollow fiber. The amount of increase can be easily calculated. The increase in efficiency is proportional to the increase in total capillary entrance area, which will increase proportionally to a slotted fiber aspect ratio A=L/D, where L is the length of the fiber and D is the cross-sectional size of the capillary.

For a practical fluid separation device with L=100 mm and D=0.01 mm, the amount of increase of efficiency of the separation device can be 10,000 times.

There are basically four types of cross-sections of slotted fibers possessing at least one continuous slot-shaped capillary along the length of a hollow fiber. The cross-sections can be formed by a gap in the fiber wall, by overlapping lobes, by parallel lobes or by diverging lobes forming the continuous capillaries. The slots formed by these techniques have a width of from 0.01 to 200 microns and preferably between 0.1 and 50 microns.

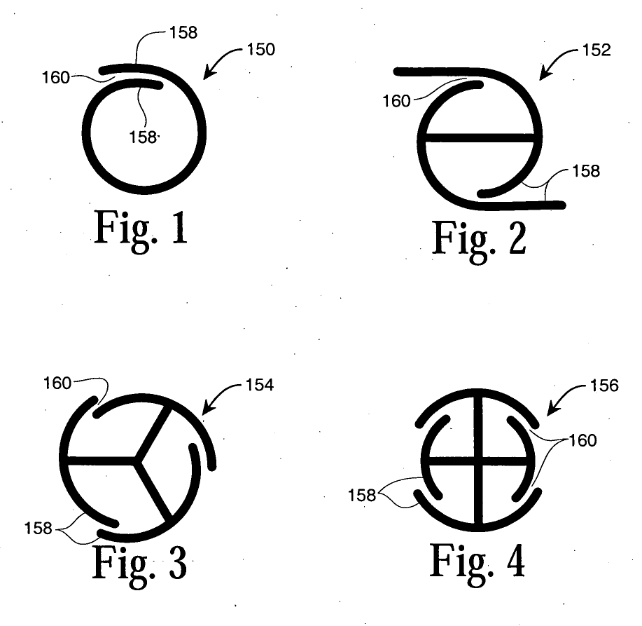

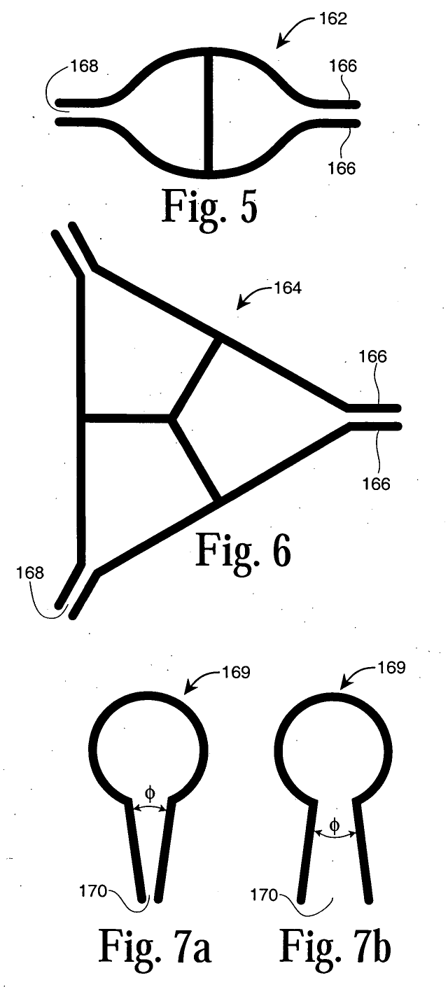

Fiber cross-sections 150, 152, 154 and 156 shown in FIGS. 1-4 are some possible cross-sections based on overlapping lobes 158 forming a continuous capillary slot 160. These overlapping lobes can form a slotted capillary whose opposing walls are either parallel, converging or diverging. Fiber cross-sections 162 and 164 shown in FIGS. 5 and 6 are two examples of fiber cross-sections based on parallel lobes 166 forming a continuous capillary slot 168. FIGS. 1-6 show some representative cross-sections shapes, but there are many other possibilities. The majority of these shapes have more than one slot that is contiguous with more than one discrete compartment in the fiber. For example, if the fiber diameter is larger, additional slots can be added. Also, the ratio of the minimum slot dimension to the fiber diameter can be varied over a wide range. Thus, it is possible to fabricate fibers with a much greater absorptive capacity than is possible with current absorbent fibers in which the absorption is on the exterior surface. Additionally, if there is more than one slot in a fiber, the interior surface of the slot and the interior surface of the fiber contiguous with that slot can have a characteristic different from that for the other slots in the fiber, thus allowing several different separations, absorptions or adsorptions in the same fiber.

Hollow fibers with at least one capillary running along their length have two broad areas of application. Used as discrete fibers as shown in FIGS. 1-6, or in woven, braided, knitted, felted, filament wound or matted form, these fibers can be used as very efficient particle filtration, absorptive materials, adsorptive materials, time-release or separation devices. When used for particle filtration, the slots are nearly impossible to clog with particulates that are generally essentially spherical in shape. When used as a time-release device, the material that has been previously placed inside the hollow fiber is accessible along the entire length of the fiber simultaneously making this a relatively fast-release device. This is in contrast to a conventional hollow fiber in which the material on the inside of the fiber is accessible only through the ends and release is controlled by diffusion. When one or both ends of the slotted fibers are connected to a manifold as described below, a separation device with essentially infinite capacity results. In addition, this type of particulate filter is easy to clean by simply pressurizing the interior of the fibers and back-flushing the fiber. For gas or liquid injection, these devices are ideal because the fibers can be in intimate contact with the second fluid along the entire length of the fiber.

To function as an absorptive material or separation device the interior surface of the slot and the interior surface of the fiber must be contiguous and possess a certain surface characteristic, such as hydrophilic, oleophilic, hydrophobic and oleophobic. Hydrophilicity and/or oleophilicity are required for an absorptive material while hydrophilicity, oleophilicity, hydrophobicity, or oleophobicity may be required for separation of a particular fluid from a fluid stream. It is usually preferable for the entire fiber to be fabricated from or coated with the same material. Thus, for example, if the interior surface of the fiber slot and the interior of the hollow fiber, and preferably the entire fiber surface, are hydrophilic, water or water-based fluids will be drawn into the interior of the hollow fiber by capillary action through a process that involves both adsorption as well as absorption.

It should be noted, however, that if the exterior surface of the hollow fiber is not the same material as the interior surfaces of the slot and the fiber, the behavior of the slotted hollow fiber will change. That is, if, for example, the interior surfaces are hydrophilic while the exterior surface is hydrophobic, liquid will not enter the slot until the appropriate pressure is reached if the walls of the slot are parallel or diverging. If the walls of the slot are converging water will spontaneously go into the slot.

Since these adsorption and absorption processes occurs along the entire length of the fiber and not just through the ends as in the prior art, this process is many orders of magnitude more rapid and more efficient. The surface of the fiber can be made hydrophilic, for example, by utilizing a hydrophilic material to fabricate the hollow fiber, by coating the fiber with hydrophilic material or by treating the surface of the fiber chemically, physically, with a plasma or corona, or with radiation to render the surface hydrophilic. Applications of this type of hydrophilic adsorbent are numerous and include medical dressings, personal hygiene articles such as diapers and tampons, “super adsorbent” textiles for fluid wipe-up, and “dry feel” textiles, which adsorb perspiration while feeling dry to the skin. The force drawing liquid into these slots will increase as the minimum dimension of the slot decreases. For most applications, the hydrophilic hollow fibers will be made from a hydrophilic polymer such as Nylon. However, for higher temperature applications or for applications that require mechanical strength or rigidity, metals or ceramic materials can also be utilized. These slotted fibers can be made from a mixture of ceramic, metal, or alloy particles in a carrier or binder using an extrusion process similar to that used for polymer extrusion. If carbon is the desired material for a particular slotted fiber application, these can easily be made by carbonizing a polymer fiber, such as polyimide or polyacrylonitrile (PAN). Glass or quartz slotted fibers, which have application in high temperature as well as corrosive environments, can be easily spun by commercial processes used to produce fiberglass and optical fibers.

In a like manner, if the surface of the fiber is oleophilic, hydrocarbons will be very efficiently drawn into the interior of the hollow fiber. If it is desired to remove a hydrocarbon material such as oil or fuel from water, the surface of the fiber can be rendered oleophilic and hydrophobic by any number of techniques, such as those described in U.S. Pat. No. 5,744,406 to Novak, U.S. Pat. No. 5,127,325 to Fadner and U.S. Pat. No. 4,101,346 to Dorsey, Jr. Thus, the slotted fibers described in this disclosure can be used individually, or they can be woven or braided to adsorb fuels, oils or fats. The hydrocarbons will enter the capillary under capillary pressure and be retained while water-based fluids will be excluded. A broad range of applications cover the gamut from cleaning up oil spills on water to removing fats and oils during food preparation.

Conversely, if it is desired to have a water-based fluid and not a hydrocarbon adsorbed by the hollow fiber, the surface of the fiber would be rendered hydrophilic and oleophobic by a process such as described in U.S. Pat. No. 5,385,175 to Rivero et al. It is possible to regenerate, i.e., empty, these hollow tubes for re-use employing techniques such as evaporation, solvation and reverse pressurization. Of course, during the same procedure the contents of the hollow tubes can be reclaimed if desired.

The slotted fibers with the cross-sections described thus far have adsorbed (and separated) on the basis of the wettability of the surface and the minimum dimension of the slot. The wettability criteria in the examples described previously is whether the contact angle of the liquid with the surface of the slot and fiber material is above or below 90°. That is, if the contact angle is below 90°, the liquid will enter the slot because of capillary force with the capillary force increasing as the contact angle decreases. On the contrary, if the contact angle of the liquid in question with the fiber surface is greater than 90°, the liquid will not spontaneously enter the capillary unless a pressure greater than that calculated from Equation (2) is applied.

It should be noted that, within limits, the rate of fluid admittance can be controlled by varying the width of the slot along the fiber. For example, with a non-wetting fluid involved, as long as the minimum dimension of the slot is not large enough to be overcome by the applied pressure as described in Equation (2), the rate of a second fluid entering the fiber can be varied by changing the slot width without admitting the non-wetting fluid.

The width of the slot in the fiber can in turn be controlled by a proper choice of manufacturing conditions or in post-processing. There are many possibilities in post-processing for control of slot width. For example, the slotted fiber could originally be manufactured with a relatively wide slot, which is subsequently narrowed by processes such as coating, oxidation, or pyrolysis. Thus, a slotted fiber can be coated with either the same material from which it was manufactured or by a different material. This can occur along the entire length of a particular slotted fiber or along only a portion of the fiber. Using a coating process, the slot width can vary in a stepwise manner, in a graded manner or a combination of the two. Alternatively, if the slotted fiber is made from a pre-ceramic polymer or is manufactured from a mixture of ceramic, metal, or alloy particles in a carrier or binder by an extrusion process, for example, the slot width can be controlled by the degree of sintering as well as the percentage of binder that is removed during processing. In the case of a polyimide tube, shrinkage of up to 22% can occur during its conversion to carbon at elevated temperatures in an inert environment.

It is also possible to allow entrance of one liquid with a contact angle of less than 90° into the slot in the hollow fiber and not allow another liquid with a different contact angle of less than 90° into the slot. This is accomplished by utilizing a hollow fiber with a tapered diverging capillary slot 169 and controlling the included angle φ at the entrance to a slot capillary 170 as seen in FIG. 7a.

In addition to employing capillaries to separate a fluid stream on the basis of wettability alone, it is possible to utilize capillaries to separate a fluid stream or mixture on the basis of the individual fluid wettability in combination with the axial or cross-sectional shape of the capillary. This is based on a relationship between the intrinsic contact angle of a fluid with a surface and the included angle φ formed by that surface. For each liquid/capillary surface pair, there is a transitional included angle that determines whether the liquid will go into a capillary with angular features.

For a wetting fluid (θ<90°), the transitional included angle is:
φ_{tw}=180°−2θ (3)

Thus, for a wetting liquid, although it wets the surface, without an applied pressure it will not spontaneously flow into the small end of a capillary that has an included angle φ greater than 180°−2θ.

It is possible to employ these relationships for the transitional included angle to separate a fluid stream or mixture on the basis of the geometric shape of a capillary. The requirements of such a device for successful separation are that there be a small included section, the contact angles of the liquid with the surface differ significantly and that the droplet size in the mixture be at least the same magnitude as the capillary dimensions. It should be noted that this technology cannot be used to separate miscible fluids.

In addition to exclusion based on an included angle, the fiber of FIG. 7a can be used in the reverse mode as a pressure or flow regulator if the walls in the tapered region are flexible. That is, the pressure of a fluid inside of the fiber or the flow of fluid out of the fiber can be controlled by the proper choice of minimum slot dimension and stiffness of the walls in the tapered region. Thus, as the pressure increases inside the fiber, the walls in the tapered region will separate to increase flow and decrease pressure. It should be noted that any slotted fiber, but particularly those in FIGS. 5-7, could also function in this manner.

In addition to being able to separate two liquids that wet the fiber surface on the basis of the included angle of the diverging slot, it is also possible to separate two liquids that do not wet the surface of the slot (θ>90°) utilizing a converging slot. In this case shown in FIG. 7b, a liquid that does not wet the exterior or slot surface will enter the slot and into the fiber if the liquid wets the fiber interior and if the included angle of the slot, φtnw, is greater than the transitional angle. The transitional included angle for a liquid that does not wet the surface of the fiber is determined by equation 4.
φ_{tnw}=2θ−180° (4)

In addition to being able to separate two liquid that do not wet the slot on the basis of the included angle of the slot, it is also possible to separate them on the basis of pressure. That is, if the entrance pressure of the two liquids as determined by equation 2 is significantly different, they can be separated on the basis of pressure, however this is not a particularly elegant technique.

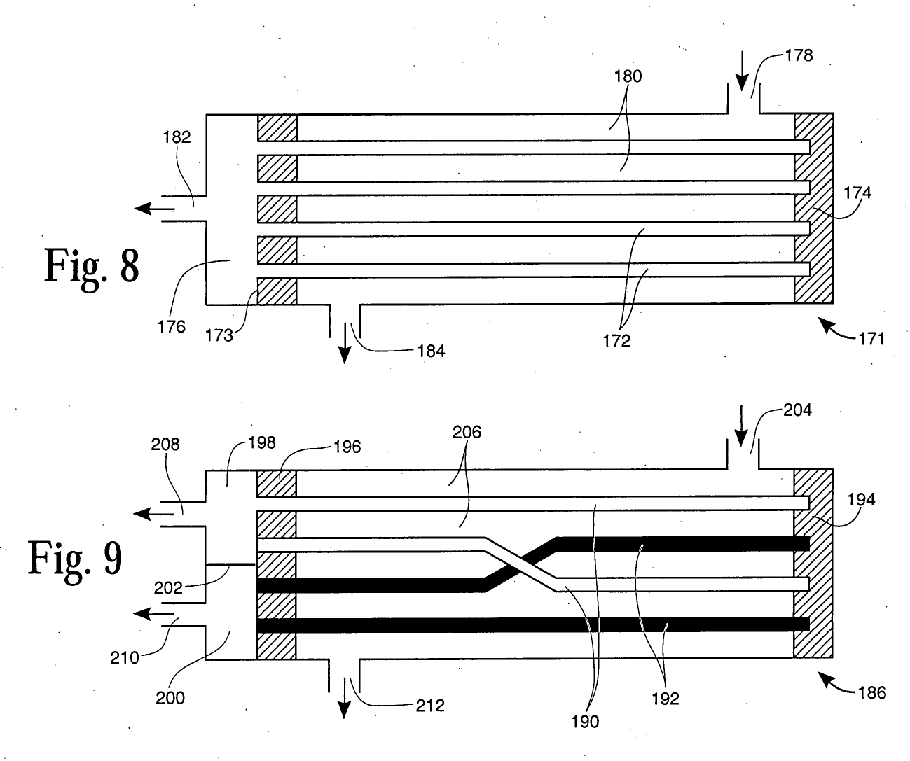

It has been demonstrated that individual slotted hollow fibers can be employed in absorption, adsorption as well as separation. However, as single fibers the amount that can be absorbed or separated is limited by the volume of the interior of the hollow fiber. If these fibers are properly manifolded, the amount of fluid that is separated can be greatly increased. The device 171 in FIG. 8 is a simple separation unit that can be used to separate one fluid from another. It can separate one fluid component (gas or liquid) out of a fluid stream entering the device 171. Slotted fibers 172 are mounted on their ends in end plates 173 and 174. The fibers are mounted in an end plate 174 in such a manner that they are not only held in place but also the ends of the fibers are sealed closed. The opposite end of the fiber(s) is (are) held in the end plate 173 in such a manner that the fiber ends are not sealed but terminate at or past the outer edge of the endplate so that the interior of the fiber(s) communicates with a chamber 176.

In this particular example embodiment, a fluid stream containing a gas dissolved in a liquid enters inlet port 178 and fills the space 180 between the fibers. The fibers are preferably close enough to touch one another, but are shown separated in the figures for the sake of clarity. By means of the inner geometry of the device and the packing density of the fibers, the fluid is forced to be in intimate contact with the fibers 172 along their entire length. The diffusional path to the fiber slots is thus short to enhance removal. Because the liquid in this embodiment has a contact angle of >90° with the fiber surface, it will be excluded from the fiber. To assist the diffusion of the gas out of the liquid and into the slotted fibers, a differential pressure can be maintained between the fluid surrounding the fibers and the interior of the fibers. This can be accomplished by pressurizing the fluid or by pulling a vacuum on chamber port 182 by a pumping device that is not shown. Due to the lower pressure inside the hollow fibers, gas dissolved in the liquid enters the slot and is removed through chamber port 182. The liquid is not able to enter the slot in the fibers due to lack of wettability and proceeds to exit fluid outlet port 184. If desired, a portion or all of the liquid that exits outlet port 184 can be recycled by bringing it into the device again through inlet port 178. To remove a gas from a water-based liquid, it is only required that the fiber surface be hydrophobic, having as high a contact angle as possible with the liquid, and that the minimum dimension of the capillary slot be small enough to require a liquid pressure according to Equation (2) for entry into the slot which is higher than the incident liquid pressure. To remove a gas from a hydrocarbon or hydrocarbon mixture, such as, an oil or a fuel, it is necessary for the fiber to have a highly oleophobic surface and that the capillary slot be small enough to exclude the liquid. Since oleophobic materials are not easily spun into fibers, the fiber can be coated after it is fabricated with an oleophobic material, such as ZONYL available from Dupont, 1H, 1H-Pentadecafluoro octyl methacrylate available from Karl Industries Inc., Sapon Laboratories Division, TG-472 available from Daikin America, Inc. or perfluoropropylene. This same device is also able to remove one immiscible liquid from another if one liquid will enter the slot and the other will not. In this case the separation rate would be enhanced if the device was oriented in such a way that port 182 was located at the bottom of the device in order that gravity might be used to assist the separation. It should be noted that this type of separation device could be operated in reverse if the liquid with the dissolved gas was flowed through the hollow tubes and the volume exterior to the fibers was evacuated. Of course, this would require that the liquid not wet the interior of the slot. It should be apparent that, the separation in this configuration would be enhanced if the fibers were mounted and sealed to separate chambers on both ends. In addition it should be noted that this type of device can also be used in reverse in order to saturate liquids with gas or to inject a liquid into a liquid stream. Thus, the separator becomes an injector without any change to the device.

A further improvement on the separation device in FIG. 8 is the separation device in FIG. 9. The construction is similar to that in FIG. 8 with the exception that there are two types of fibers 190 and 192 with different slot and interior surfaces. In addition, although one end of each type of fiber is sealed in endplate 194, the open ends of these two types of fibers are held in endplate 196 and terminate in two different chambers 198 and 200 formed by divider 202. In this device, the fluid stream or mixture to be separated enters the device through inlet port 204 and completely fills the space 206. By means of the inner geometry of the device and the packing density of the fibers, the fluid is forced to be in intimate contact with all the fibers 190 and 192 along their entire length. The surfaces of the two types of fibers are chosen so that only one fluid in the fluid stream that enters the device will enter that particular fiber due to wettability. Fibers 190 are wetted by a first component in the fluid stream and have a contact angle of >90° with all the other components of the fluid stream entering the device. Fibers 192 are wetted by a second component in the fluid stream and have a contact angle of >90° with all the other components of the fluid stream entering the device. Thus, this type of device can be used to separate at least two liquids from a stream or mixture or to separate a gas and at least one liquid from another. In this particular embodiment, a first fluid component of the fluid stream entering inlet port 204 will be able to enter fiber 190. It will then exit the fiber into chamber 198 and exit the device through chamber port 208. Likewise, a second fluid component of the fluid stream entering inlet port 204 will be able to enter fiber 192. It will then exit the fiber into chamber 200 and exit the device through chamber port 210. Any liquid that does not enter hollow slotted fibers 190 and 192 will exit the device through exit port 212.

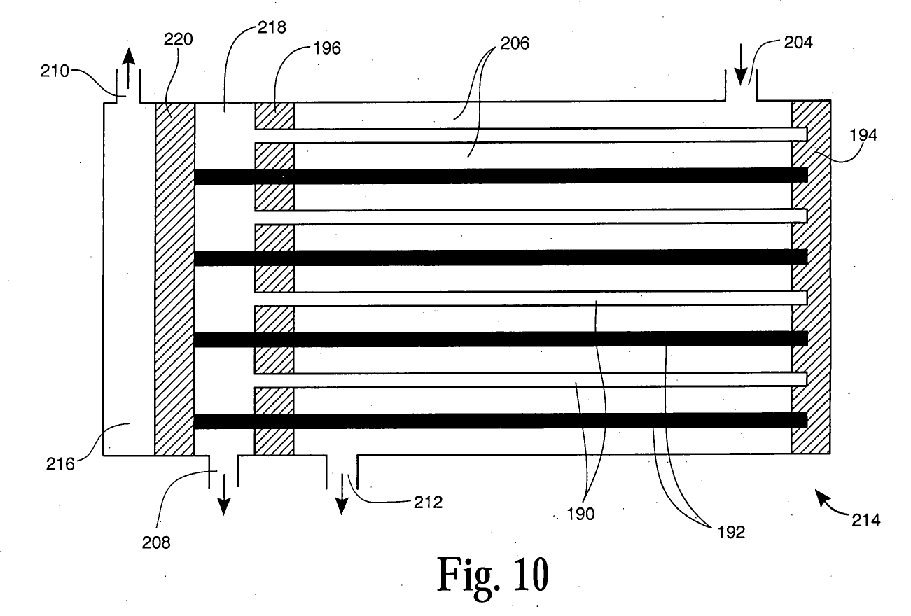

FIG. 10 is a slight variation on FIG. 9 to better clarify the technology. In this device 214 the different kinds of-fibers 190 and 192 have different lengths and terminate in different vertical chambers 216 and 218 separated by a divider 220 that also serves as the endplate for fibers.

Several additional points can be made about this type of separation device. For example, this device can be employed in reverse to be used as a static fluid mixer, reactor or a gas injection system. It should also be noted that in any separation device utilizing slotted fibers, there is no limit to the number of different types of fibers that can be utilized. In addition, it is possible for a fiber to admit more than one fluid in the incident fluid stream and exclude all others.

When used in the reverse mode, a liquid or a gas can be injected into the incident fluid stream. The purpose may be to dissolve a gas in a liquid, mix at least two liquids or gases intimately together, or form liquid droplets in a gas stream. To enhance a chemical reaction, these injection devices can be employed to inject one reactant intimately into another. Alternatively, the inside of the slotted fiber can act as a micro-reactor for one or more components, which react and are then injected into another fluid stream for possible further reaction. If a heterogeneous catalyst is placed on the inside or outside of the slotted fiber or if the fiber itself is catalytic, the reactant(s) will be forced into intimate contact with the catalytic surface and each other much like reactants in a zeolite. This will further increase the efficiency of the reactor.

Downstream of this reactor a separation device can be employed to remove one or more products of the reaction in order to separate and collect the products or to simply shift the equilibrium of a reaction by removal of at least one product in order to bring the reaction toward completion. By reducing the concentration of one component in the mixture undergoing reaction, the overall equilibrium for the particular chemical reaction under consideration will shift toward formation of additional reaction products that have been removed; as a result, a more complete conversion of initial reactants to products is obtained.

In addition, by employing the fibers of the present invention, it is possible to operate gas phase reactions at optimum pressures and still obtain a desirable conversion. Likewise it is possible to operate in temperature ranges of less favorable equilibrium constants at which undesirable side reactions may be repressed or entirely eliminated. In these chemical reactors and separators, slotted hollow fibers have the advantage over porous hollow fibers in that they do not depend simply on diffusion of small molecules through the wall. Porous hollow fibers only allow the transport of small molecules like hydrogen through the wall while slotted fibers allow any reactant or product to move from one side of the hollow fiber to the other.

In the separation devices shown in FIGS. 8-10, both end of the fibers could be manifolded in such a way that the interior of the fibers are in communication with a chamber, such as 176, 198, 200, 216 or 218, on both ends instead of being blocked on one end so that efficiency of removal or injection could be increased.

The slotted hollow fibers in this invention can easily have 10,000 times the capillary entrance surface area and therefore 10,000 the absorption and separation efficiency as hollow fibers of the prior art. Because of the short distance from the slot to the center of the hollow fiber, the speed of adsorption and absorption is greatly increased. In addition, due to the uniformity of the slots' width and depth, the separation and absorption properties of the fiber are consistently uniform as compared to random media, where the flow path for particles may vary.

The slotted fiber cross-sections of this invention can be formed by normal fiber extrusion processes, such as single component spinning, single component spinning with gas injection and bi-component spinning. U.S. Pat. No. 4,254,181 to Bromley et al. and U.S. Pat. No. 4,325,765 to Yu et al. describe single component spinning of so-called non-round filaments.

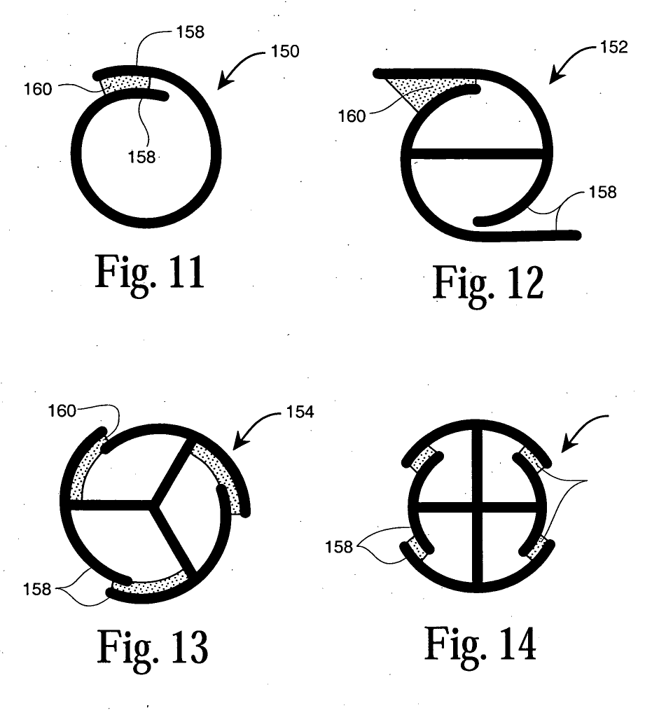

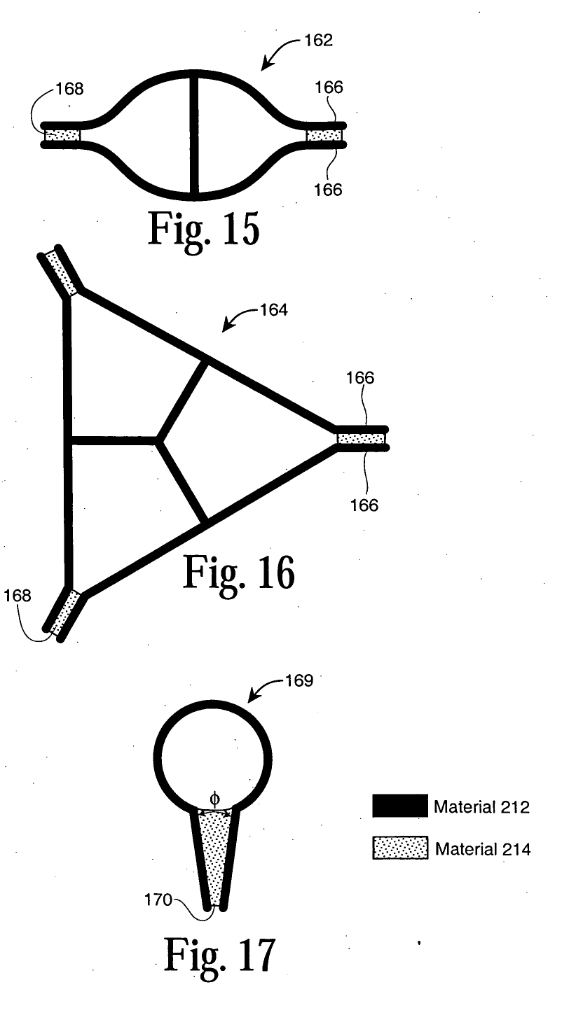

Conventional fiber spinning processes require extremely precise control of the viscosity of the material being spun, the pressure forcing this material through the spinnerette, as well as the tension on the resulting fiber strand to form slots of microscopic dimensions in fibers. In particular, forming slotted fibers such as shown in this description require careful and continuous control of polymer feeding and fiber draw rates to achieve a desired final net shape. In order to closely control slot shapes and sizes with less effort, and more easily make long continuous lengths, a bi-component fiber spinning method may have advantages over more conventional spinning methods utilizing a single material. When extruding two different materials together through a spinnerette capillary, a second material can be used to precisely define the size and shape of the slot as seen in FIGS. 11-17. By precisely controlling the flow of the second material through the spinnerette, the slot shapes and dimensions will be controlled with great precision. This material, used to define the size and shape of the slots, is a fugitive or sacrificial material that is later removed by some means such as solvation, vaporization, or oxidation.

In the example embodiments of FIGS. 11-17, a first material 212 is the material from which the slotted fiber is formed. It may be any material that is extrudable, such as a thermoplastic polymer or a glass, as well as a mixture of ceramic, metal, or alloy particles in a carrier or binder. In addition, it can be either hydrophobic (polypropylene, polyethylene Teflon, etc.) or hydrophilic (nylon, polymethylacrilate, metals, alloys, etc.) in nature, depending on the slotted fiber application. It can be either oleophobic or oleophilic as well as any combination, such as hydrophilic and oleophilic, oleophobic and hydrophilic, hydrophobic and oleophobic or hydrophobic and oleophilic.

Material 214 is a sacrificial material and is chosen based on its ease of complete removal after fiber formation. This removal criterion might be satisfied by its solubility properties, such as polyvinyl alcohol in water, or its ability to completely vaporize without leaving a residue, such as polyalphamethylstyrene.

The slot shapes and dimensions can be controlled with great precision by adjusting the flow of material 214 through spinning heads allowing flow of two separate materials.

After subjecting the bi-component fiber to the thermal, chemical or solvation treatment needed to remove material 214 the fibers assume their final shapes shown in FIGS. 1-7.

The disclosed new separation devices, their component axially slotted fibers and methods for making such devices and fibers successfully demonstrate the use and value of such axially slotted fibers. Although the disclosed devices and component materials are specialized, their teachings will find application in other areas where a well-known physical property, such as capillary action, and devices utilizing those properties, can be improved.

It is understood that various modifications to the invention as described may be made, as might occur to one with skill in the field of the invention, within the scope of the claims. Therefore, all embodiments contemplated have not been shown in complete detail. Other embodiments may be developed without departing from the spirit of the invention or from the scope of the claims.

We claim:

1. An absorptive material with enhanced rate and capacity of absorption comprising at least one hollow fiber having at least one axial slot along a substantial section of said fiber's length.

2. The absorptive material according to claim 1, the axial slot having an interior surface, the hollow fiber having an interior surface contiguous with the axial slot interior surface, and the hollow fiber having an exterior surface, wherein the interior surface of the axial slot, the interior surface of the hollow fiber that is contiguous with the interior surface of the axial slot, and the exterior surface of the hollow fiber each having a surface characteristic selected from the group consisting of hydrophilic, oleophilic, hydrophobic and oleophobic.

3. The absorptive material according to claim 1, wherein said at least one axial slot has a width of from 0.01 to 200 microns and forms a continuous capillary with the fiber interior.

4. The absorptive material according to claim 3, wherein the at least one axial slot is formed by any employment of a gap in the fiber wall, by overlapping lobes, by parallel lobes, by diverging lobes, and by converging lobes.

5. The absorptive material according to claim 3, wherein said at least one axial slot has a width of from 0.01 to 50 microns.

6. The absorptive material according to claim 2, wherein the interior surface of the at least one axial slot, the interior surface of the hollow fiber that is contiguous with interior surface of the at least one axial slot, and the exterior surface of the fiber have a separation characteristic resulting from any of the surface characteristics and an included angle between opposing faces of the axial slot.

7. The absorptive material according to claim 1 comprising at least two hollow fibers, wherein the hollow fibers are joined to each other by any of weaving, matting, braiding, knitting, felting, and filament winding.

8. A fluid separation device comprising a plurality of hollow fibers, each hollow fiber having at least one axial slot along a substantial section of the fiber's length.

9. The fluid separation device according to claim 8, wherein the hollow fibers selectively absorb at least one fluid from a mixture.

10. The fluid separation device according to claim 9, said fluid separation device having a fluid inlet port, a fluid outlet port, at least one chamber, and at least one chamber port, said fluid separation device comprising two distinct volumes that communicate with one another through the axial slots in the hollow fibers; said first volume comprising the interior of the hollow fibers, the interior of the chamber wherein the hollow fibers are sealed and joined to each other, and the interior of the at least one chamber port that communicates from at least one chamber through the exterior wall of the device to the exterior of the device; said second volume comprising the interior volume of the fluid separation device that is exterior to the hollow fibers, and the interior volumes of the fluid inlet port and the fluid outlet port.

11. The fluid separation device according to claim 10, each axial-slot having an interior surface, each hollow fiber having an interior surface contiguous with the axial slot interior surface, and each hollow fiber having an exterior surface, wherein the interior surface of the axial slot, the interior surface of the hollow fiber that is contiguous with the interior surface of the axial slot, and the exterior surface of the hollow fiber each having a surface characteristic selected from the group consisting of hydrophilic, oleophilic, hydrophobic and oleophobic.

12. The fluid separation device according to claim 10, wherein each axial slot has a width of from 0.01 to 200 microns and forms a continuous capillary with the fiber interior.

13. The fluid separation device according to claim 12, the at axial slots being formed by any of a gap in the fiber wall, by overlapping lobes, by parallel lobes, by diverging lobes, and by converging lobes.

14. The fluid separation device according to claim 12, wherein said axial slots have a width of from 0.1 to 50 microns.

15. The fluid separation device according to claim 11, wherein the interior surface of the axial slots, the interior surface of the hollow fiber that is contiguous with interior surface of the axial slot, and the exterior surface of the fiber having a separation characteristic resulting from any of surface characteristics and an included angle between opposing faces of the axial slot.

16. The fluid separation device according to claim 10, in which there are more than one type of hollow fiber comprising axial slots with different separation characteristics; each type of hollow fiber being joined and sealed to a different chamber having its own port.

17. The fluid separation device according to claim 10 in which the hollow fibers with axial slots are joined and sealed to separate chambers on both ends of the hollow fiber; each said chamber having its own port.

18. A method for making a hollow fiber with an axial slot, comprising the steps of:
(a) extruding the hollow fiber as a bi-component fiber comprising a final material and a sacrificial material, the final material having a pre-selected cross-sectional shape partially defined by the sacrificial material; and,
(b) removing the sacrificial material to leave a single component hollow fiber having the pre-selected cross-sectional shape.
